(19) United States
(12) Patent Application Publication
(10) Pub. No.: US 2014/0054972 A1
(43) Pub. Date: Feb. 27, 2014

(54) WIRELESS POWER TRANSMISSION SYSTEM

(71) Applicant: TDK CORPORATION, Tokyo (JP)

(72) Inventors: Akira GOTANI, Tokyo (JP); Mitsunari SUZUKI, Tokyo (JP)

(73) Assignee: TDK CORPORATION, Tokyo (JP)

(21) Appl. No.: 13/964,179

(22) Filed: Aug. 12, 2013

(30) Foreign Application Priority Data
Aug. 24, 2012 (JP) 2012-185634

(51) Int. Cl. H01F 38/14

(52) U.S. Cl. CPC H01F 38/14
USPC 307/104

(57) ABSTRACT

In a wireless power transmission system, a wireless power feeder supplies alternating current power from a power supply to a feeding coil at a resonant frequency f0 to generate an alternating current magnetic field of the resonant frequency f0. A receiving coil receives the power with the alternating current magnetic field of the resonant frequency f0. This received power is consumed in a load in a wireless power receiver. The impedance ratio between the receiving coil and the load, the quality factor of the feeding coil, and the quality factor of the receiving coil are appropriately set to keep high power transmission efficiency.

### BACKGROUND OF THE INVENTION

1. Field of the Invention

The present invention relates to a wireless power transmission system.

2. Description of the Related Art

Wireless power transmission systems have been developed on demand to be in practical use, which externally supply power to the batteries of, for example, electronic devices with no mechanical contact with cables or the likes.

Such a wireless power transmission system supplies the power from a feeding coil at a power feeding side to a receiving coil at a power receiving side on the basis of a mutual induction effect of electromagnetic induction. Specifically, a magnetic flux is generated at the feeding coil in a power feeding unit to produce induced electromotive force at the receiving coil that is positioned near the feeding coil in a non-contact manner with an air gap and that is mounted in an electronic device, etc., thereby supplying the power.

Demands for improvement of power transmission efficiency, expansion of the air gap, support of a positional shift between the feeding coil and the receiving coil, and reduction in size and weight are increased in the wireless power transmission system to advance the development in order to accommodate the demands.

Japanese Unexamined Patent Application Publication No. 2009-501510 describes a wireless power transmission system having a resonator structure in which both the power feeding unit and the power receiving unit are each composed of a coil and a capacitor. The Q value of the resonator is not lower than 100. Japanese Unexamined Patent Application Publication No. 2008-259419 describes a wireless power transmission system that feeds power in a non-contact manner to a traveling body travelling along an orbit. In the wireless power transmission system, the power feeding unit has a circuit configuration including only a coil and the power receiving unit has a circuit configuration composing a series resonance circuit in which a coil and a capacitor are connected in series to each other. Japanese Unexamined Patent Application Publication No. 2005-27401 also describes a wireless power transmission system having circuit configurations of the power feeding unit and the power receiving unit, which are similar to those in the wireless power transmission system described in Japanese Unexamined Patent Application Publication No. 2008-259419.

However, the wireless power transmission system in which both the power feeding unit and the power receiving unit has the resonator structure, described in Japanese Unexamined Patent Application Publication No. 2009-501510, has a problem in that the wireless power transmission system has two frequency bands having high power transmission efficiencies and a variation in distance between the feeding coil and the receiving coil varies the frequencies having high power transmission efficiencies to make difficult to keep the high-efficiency power transmission. In addition, since the wireless power transmission system described in Japanese Unexamined Patent Application Publication No. 2009-501510 includes the power feeding unit having the resonator structure composed of a coil and a capacitor, the number of the components is increased to possibly increase the size of the power feeding unit and increase the cost.

The wireless power transmission systems described in Japanese Unexamined Patent Application Publication No. 2008-259419 and Japanese Unexamined Patent Application Publication No. 2005-27401, in which the power feeding unit has the circuit configuration including only a coil and the power receiving unit has the circuit configuration composing a series resonance circuit in which a coil and a capacitor are connected in series to each other, do not have the problem in that the variation in distance between the feeding coil and the receiving coil varies the frequencies having high power transmission efficiencies. However, the air gap between the feeding coil in the power feeding unit and the receiving coil in the power receiving unit is narrow in related art and the maintenance of the power transmission efficiency by expanding the air gap is not considered to cause a problem in that the power transmission efficiency is drastically reduced if the air gap is expanded.

### SUMMARY OF THE INVENTION

In order to resolve the above problems, it is an object of the present invention to provide a wireless power transmission system in which a power feeding unit has a circuit configuration including only a feeding coil and a power receiving unit has a circuit configuration composing a series resonance circuit including a receiving coil and a receiving capacitor and which is capable of keeping high power transmission efficiency even with an air gap or a positional shift between the feeding coil and the receiving coil within a certain coupling coefficient range by appropriately setting the impedance ratio between the receiving coil and a load, the quality factor of the feeding coil, and the quality factor of the receiving coil.

The inclusion of only the feeding coil means that no capacitor is added, in addition to the feeding coil. A parasitic capacitance component occurring at the feeding coil is much smaller than that occurring at the receiving capacitor. Accordingly, the power feeding unit does not form a resonance circuit using the resonant frequency of the series resonance circuit of the power receiving unit as a resonance point.

According to a first embodiment, a wireless power transmission system includes a wireless power feeder and a wireless power receiver. The wireless power feeder includes a feeding coil and a power circuit that supplies alternating current to the feeding coil at a drive frequency to cause the feeding coil to feed alternating current power to a receiving coil. The wireless power receiver includes the receiving coil, a receiving capacitor forming a series resonance circuit with the receiving coil, and a load that consumes the alternating current power received from the feeding coil by the receiving coil. When ω0*L2/RL resulting from division of a product of a resonant angular frequency ω0, which is a product of a resonant frequency determined by the receiving coil and the receiving capacitor and 2π, and an inductance value L2 of the receiving coil by a value RL of the load is not lower than two and is not higher than 12, a quality factor of the receiving coil is 50 or higher and a quality factor of the feeding coil is 55 or higher.

According to a second embodiment, a wireless power transmission system includes a wireless power feeder and a wireless power receiver. The wireless power feeder includes a feeding coil and a power circuit that supplies alternating current to the feeding coil at a drive frequency to cause the feeding coil to feed alternating current power to a receiving coil. The wireless power receiver includes the receiving coil, a receiving capacitor forming a series resonance circuit with the receiving coil, and a load that consumes the alternating current power received from the feeding coil by the receiving coil. When ω0*L2/RL resulting from division of a product of a resonant angular frequency ω0, which is a product of a resonant frequency determined by the receiving coil and the receiving capacitor and 2π, and an inductance value L2 of the receiving coil by a value RL of the load is not lower than one and is lower than two, a quality factor of the receiving coil is 50 or higher and a quality factor of the feeding coil is 105 or higher.

According to a third embodiment, a wireless power transmission system includes a wireless power feeder and a wireless power receiver. The wireless power feeder includes a feeding coil and a power circuit that supplies alternating current to the feeding coil at a drive frequency to cause the feeding coil to feed alternating current power to a receiving coil. The wireless power receiver includes the receiving coil, a receiving capacitor forming a series resonance circuit with the receiving coil, and a load that consumes the alternating current power received from the feeding coil by the receiving coil. When ω0*L2/RL resulting from division of a product of a resonant angular frequency ω0, which is a product of a resonant frequency determined by the receiving coil and the receiving capacitor and 2π, and an inductance value L2 of the receiving coil by a value RL of the load is not lower than 0.5 and is lower than one, a quality factor of the receiving coil is 50 or higher and a quality factor of the feeding coil is 205 or higher.

When the quality factor of the receiving coil is 50 or higher and lower than 55, the quality factor of the feeding coil is 55 or higher, and when the quality factor of the receiving coil is 55 or higher, the quality factor of the feeding coil is higher than or equal to the quality factor of the receiving coil.

When the quality factor of the receiving coil is 50 or higher and lower than 105, the quality factor of the feeding coil is 105 or higher, and when the quality factor of the receiving coil is 105 or higher, the quality factor of the feeding coil is higher than or equal to the quality factor of the receiving coil.

When the quality factor of the receiving coil is 50 or higher and lower than 205, the quality factor of the feeding coil is 205 or higher, and when the quality factor of the receiving coil is 205 or higher, the quality factor of the feeding coil is higher than or equal to the quality factor of the receiving coil.

The wireless power feeder is preferably configured so as to include no capacitor in series or in parallel for the feeding coil.

According to the present invention, in the wireless power transmission system in which the power feeding unit has the circuit configuration including only the feeding coil and the power receiving unit has the circuit configuration composing the series resonance circuit including the receiving coil and the receiving capacitor, it is possible to keep high power transmission efficiency even with an air gap or a positional shift between the feeding coil and the receiving coil within a certain coupling coefficient range by appropriately setting the impedance ratio between the receiving coil and the load, the quality factor of the feeding coil, and the quality factor of the receiving coil.

### BRIEF DESCRIPTION OF THE DRAWINGS

FIG. 1 is a diagram illustrating the principle of a wireless power transmission system according to first and second embodiments of the present invention;

FIG. 2 illustrates a feeding coil in detail;

FIG. 3 is a graph indicating the relationship between a quality factor ω0*L1/r1 of the feeding coil and a quality factor ω0*L2/r2 of a receiving coil, in which ω0*L2/RL representing the impedance ratio between the receiving coil and a load is not lower than two and is not higher than 12 and in which both a power transmission efficiency of 20% or higher with a coupling coefficient k being set to 0.05 and a power transmission efficiency of 80% or higher with the coupling coefficient k being set to 0.5 are satisfied;

FIG. 4 is a graph indicating the relationship between the quality factor ω0*L1/r1 of the feeding coil and the quality factor ω0*L2/r2 of the receiving coil, in which ω0*L2/RL representing the impedance ratio between the receiving coil and the load is not lower than one and is lower than two and in which both the power transmission efficiency of 20% or higher with the coupling coefficient k being set to 0.05 and the power transmission efficiency of 80% or higher with the coupling coefficient k being set to 0.5 are satisfied;

FIG. 5 is a graph indicating the relationship between the quality factor ω0*L1/r1 of the feeding coil and the quality factor ω0*L2/r2 of the receiving coil, in which ω0*L2/RL representing the impedance ratio between the receiving coil and the load is not lower than 0.5 and is lower than one and in which both the power transmission efficiency of 20% or higher with the coupling coefficient k being set to 0.05 and the power transmission efficiency of 80% or higher with the coupling coefficient k being set to 0.5 are satisfied;

FIG. 6 is a graph indicating the relationship between the quality factor ω0*L1/r1 of the feeding coil and the quality factor ω0*L2/r2 of the receiving coil, in which ω0*L2/RL representing the impedance ratio between the receiving coil and the load is not lower than two and is not higher than 12, in which both the power transmission efficiency of 20% or higher with the coupling coefficient k being set to 0.05 and the power transmission efficiency of 80% or higher with the coupling coefficient k being set to 0.5 are satisfied, and in which a condition that the quality factor ω0*L1/r1 of the feeding coil is higher than or equal to the quality factor ω0*L2/r2 of the receiving coil;

FIG. 7 is a graph indicating the relationship between the quality factor ω0*L1/r1 of the feeding coil and the quality factor ω0*L2/r2 of the receiving coil, in which ω0*L2/RL representing the impedance ratio between the receiving coil and the load is not lower than one and is lower than two, in which both the power transmission efficiency of 20% or higher with the coupling coefficient k being set to 0.05 and the power transmission efficiency of 80% or higher with the coupling coefficient k being set to 0.5 are satisfied, and in which the condition that the quality factor ω0*L1/r1 of the feeding coil is higher than or equal to the quality factor ω0*L2/r2 of the receiving coil; and

FIG. 8 is a graph indicating the relationship between the quality factor ω0*L1/r1 of the feeding coil and the quality factor ω0*L2/r2 of the receiving coil, in which ω0*L2/RL representing the impedance ratio between the receiving coil and the load is not lower than 0.5 and is lower than one, in which both the power transmission efficiency of 20% or higher with the coupling coefficient k being set to 0.05 and the power transmission efficiency of 80% or higher with the coupling coefficient k being set to 0.5 are satisfied, and in which the condition that the quality factor ω0*L1/r1 of the feeding coil is higher than or equal to the quality factor ω0*L2/r2 of the receiving coil.

### DESCRIPTION OF THE PREFERRED EMBODIMENTS

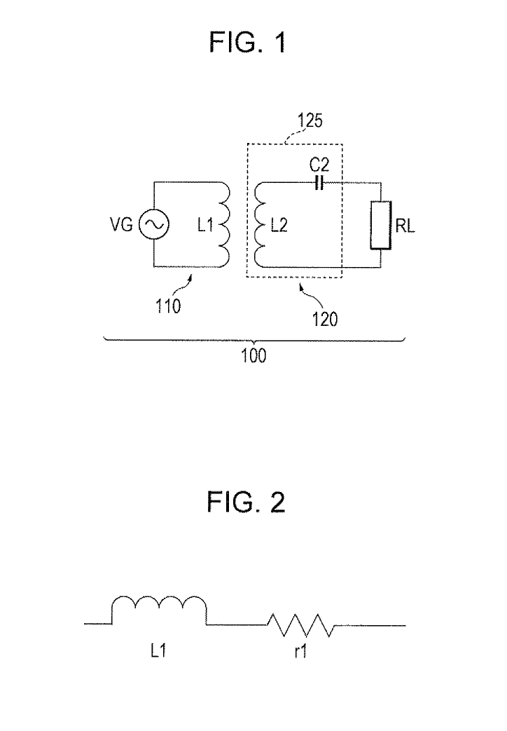

FIG. 1 is a diagram illustrating the principle of a wireless power transmission system 100 according to first and second embodiments of the present invention. The wireless power transmission system 100 according to the first and second embodiments includes a wireless power feeder 110 and a wireless power receiver 120. The wireless power feeder 110 includes a power supply VG and a feeding coil L1. The wireless power receiver 120 includes a power receiving series LC resonance circuit 125 and a load RL. The power receiving series LC resonance circuit 125 includes a receiving coil L2 and a receiving capacitor C2. A resonant frequency determined by the receiving coil L2 and the receiving capacitor C2 is denoted by f0. A resonant angular frequency calculated from a product of the resonant frequency f0 and 2π is denoted by ω0. A numerical value indicating the coupling state between the feeding coil L1 and the receiving coil L2 is represented by a coupling coefficient k.

Upon supply of alternating current (AC) power from the power supply VG to the feeding coil L1 at the resonant frequency f0 by the wireless power feeder 110, the feeding coil L1 generates an alternating current magnetic field of the resonant frequency f0. The receiving coil L2 receives the power with the alternating current magnetic field of the resonant frequency f0. This received power is consumed in the load RL in the wireless power receiver 120.

FIG. 2 illustrates the feeding coil L1 in detail. Although the feeding coil L1 is ideally composed of an inductance component, the feeding coil L1 practically serially includes a feeding coil series resistor r1, such as a terminal electrode. A quality factor determined by the resonant angular frequency ω0, the feeding coil L1, and the feeding coil series resistor r1 is denoted by ω0*L1/r1. Similarly, a quality factor determined by the resonant angular frequency ω0, the receiving coil L2, and a receiving coil series resistor r2 serially included in the receiving coil L2 is denoted by ω0*L2/r2.

### First Embodiment

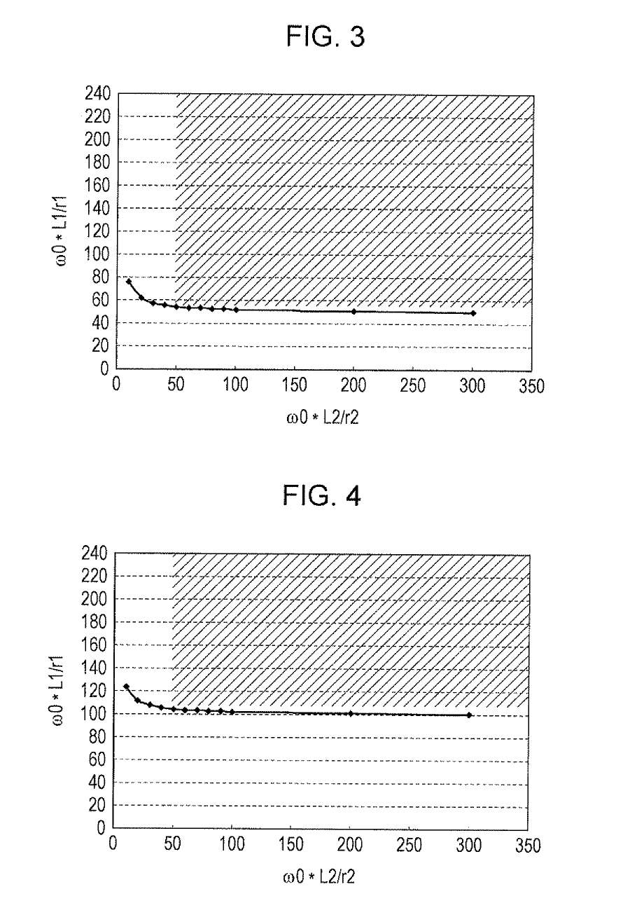

A hatched portion in FIG. 3 indicates an area in which ω0*L2/RL representing the impedance ratio between the receiving coil L2 and the load RL is not lower than two and is not higher than 12 and in which both a power transmission efficiency of 20% or higher with the coupling coefficient k being set to 0.05 and a power transmission efficiency of 80% or higher with the coupling coefficient k being set to 0.5 are satisfied, in a graph indicating the relationship between the quality factor ω0*L1/r1 of the feeding coil L1 and the quality factor ω0*L2/r2 of the receiving coil L2. The power transmission efficiency of 20% or higher with the coupling coefficient k being set to 0.05 and the power transmission efficiency of 80% or higher with the coupling coefficient k being set to 0.5 are practically required for the wireless power transmission.

The resonant angular frequency ω0 is equal to 628318.5 rad/sec when the resonant frequency f0 is set to 100 kHz, and setting the inductance value of the receiving coil L2 to 100 μH and the value of the load RL to 31.4Ω makes ω0*L2/RL equal to two.

When the inductance value of the feeding coil L1 is set to 100 μH, the capacitance value of the receiving capacitor C2 is equal to 0.0253 μF from the inductance value of the receiving coil L2 and the resonant frequency f0. It is desirable for the receiving capacitor C2 to have a lower dielectric los tangent tan δ in order to improve the power transmission efficiency. Capacitors having low tan δ include capacitors having low dielectric constants.

The upper limits of the quality factor ω0*L1/r1 of the feeding coil L1 and the quality factor ω0*L2/r2 of the receiving coil L2 are determined by the shapes and/or materials of the coils and generally have values of about several thousands. Decreasing the value of the feeding coil series resistor r1 of the feeding coil L1 and the value of the receiving coil series resistor r2 of the receiving coil L2 allows losses at the feeding coil L1 and the receiving coil L2 to be reduced, thereby improving the power transmission efficiency. A secondary battery is supposed as the load RL, in addition to a rectifier and a direct current (DC)-DC converter, and the load RL has a value of a few ohms to a few hundred ohms.

When ω0*L2/RL is not lower than two and is not higher than 12, in order to satisfy both the power transmission efficiency of 20% or higher with the coupling coefficient k being set to 0.05 and the power transmission efficiency of 80% or higher with the coupling coefficient k being set to 0.5, the quality factor ω0*L1/r1 of the feeding coil L1 has a value of 55 or higher when the quality factor ω0*L2/r2 of the receiving coil L2 has a value of 50 or higher.

As described above, when ω0*L2/RL is not lower than two and is not higher than 12, setting the value of the quality factor ω0*L2/r2 of the receiving coil L2 to 50 or higher and the value of the quality factor ω0*L1/r1 of the feeding coil L1 to 55 or higher allows both the power transmission efficiency of 20% or higher with the coupling coefficient k being set to 0.05 and the power transmission efficiency of 80% or higher with the coupling coefficient k being set to 0.5, which are practically required for the wireless power transmission, to be satisfied. In addition, the power transmission efficiency with the coupling coefficient being set to a value from 0.05 to 0.5 is monotonically increased with the increasing coupling coefficient to achieve the excellent power transmission efficiency.

A hatched portion in FIG. 4 indicates an area in which ω0*L2/RL is not lower than one and is lower than two and in which both the power transmission efficiency of 20% or higher with the coupling coefficient k being set to 0.05 and the power transmission efficiency of 80% or higher with the coupling coefficient k being set to 0.5 are satisfied, in a graph indicating the relationship between the quality factor ω0*L1/r1 of the feeding coil L1 and the quality factor ω0*L2/r2 of the receiving coil L2.

The resonant angular frequency ω0 is equal to 628318.5 rad/sec when the resonant frequency f0 is set to 100 kHz, and setting the inductance value of the receiving coil L2 to 100 μH and the value of the load RL to 62.8Ω makes ω0*L2/RL equal to one.

When the inductance value of the feeding coil L1 is set to 100 μH, the capacitance value of the receiving capacitor C2 is equal to 0.0253 μF from the inductance value of the receiving coil L2 and the resonant frequency f0.

When ω0*L2/RL is not lower than one and is lower than two, in order to satisfy both the power transmission efficiency of 20% or higher with the coupling coefficient k being set to 0.05 and the power transmission efficiency of 80% or higher with the coupling coefficient k being set to 0.5, the quality factor ω0*L1/r1 of the feeding coil L1 has a value of 105 or higher when the quality factor ω0*L2/r2 of the receiving coil L2 has a value of 50 or higher.

As described above, when ω0*L2/RL is not lower than one and is lower than two, setting the value of the quality factor ω0*L2/r2 of the receiving coil L2 to 50 or higher and the value of the quality factor ω0*L1/r1 of the feeding coil L1 to 105 or higher allows both the power transmission efficiency of 20% or higher with the coupling coefficient k being set to 0.05 and the power transmission efficiency of 80% or higher with the coupling coefficient k being set to 0.5, which are practically required for the wireless power transmission, to be satisfied.

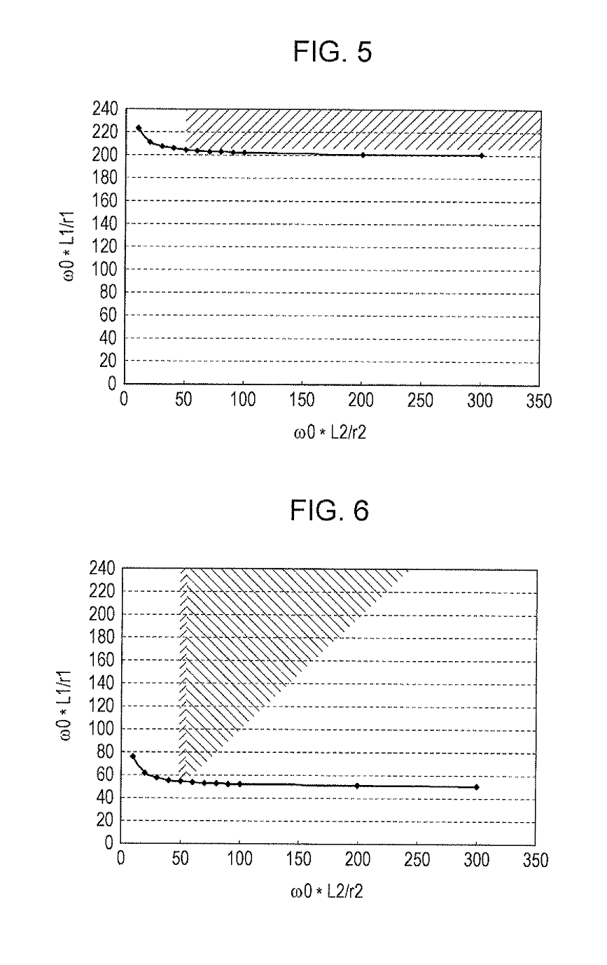

A hatched portion in FIG. 5 indicates an area in which ω0*L2/RL is not lower than 0.5 and is lower than one and in which both the power transmission efficiency of 20% or higher with the coupling coefficient k being set to 0.05 and the power transmission efficiency of 80% or higher with the coupling coefficient k being set to 0.5 are satisfied, in a graph indicating the relationship between the quality factor ω0*L1/r1 of the feeding coil L1 and the quality factor ω0*L2/r2 of the receiving coil L2.

The resonant angular frequency ω0 is equal to 628318.5 rad/sec when the resonant frequency f0 is set to 100 kHz, and setting the inductance value of the receiving coil L2 to 100 μH and the value of the load RL to 125.6Ω makes ω0*L2/RL equal to 0.5.

When the inductance value of the feeding coil L1 is set to 100 μH, the capacitance value of the receiving capacitor C2 is equal to 0.0253 μF from the inductance value of the receiving coil L2 and the resonant frequency f0.

When ω0*L2/RL is not lower than 0.5 and is lower than one, in order to satisfy both the power transmission efficiency of 20% or higher with the coupling coefficient k being set to 0.05 and the power transmission efficiency of 80% or higher with the coupling coefficient k being set to 0.5, the quality factor ω0*L1/r1 of the feeding coil L1 has a value of 205 or higher when the quality factor ω0*L2/r2 of the receiving coil L2 has a value of 50 or higher.

As described above, when ω0*L2/RL is not lower than 0.5 and is lower than one, setting the value of the quality factor ω0*L2/r2 of the receiving coil L2 to 50 or higher and the value of the quality factor ω0*L1/r1 of the feeding coil L1 to 205 or higher allows both the power transmission efficiency of 20% or higher with the coupling coefficient k being set to 0.05 and the power transmission efficiency of 80% or higher with the coupling coefficient k being set to 0.5, which are practically required for the wireless power transmission, to be satisfied.

In the first embodiment, no capacitor is provided for the feeding coil L1 in series and in parallel. In addition, the parasitic capacitance component occurring at the feeding coil L1 is much smaller than that occurring at the receiving capacitor C2. Accordingly, the power feeding unit does not form a resonance circuit using the resonant frequency f0 of the power receiving series LC resonance circuit 125 as the resonance point. Accordingly, the problem in that the variation in distance between the feeding coil L1 and the receiving coil L2 varies the frequencies having high power transmission efficiencies does not occur. Furthermore, since no capacitor is required in the power feeding unit, the number of the components is reduced to achieve advantages in size and cost.

### Second Embodiment

In order to improve the power transmission efficiency, it is sufficient to increase the quality factor ω0*L1/r1 of the feeding coil L1 and the quality factor ω0*L2/r2 of the receiving coil L2. However, the receiving coil L2 is severely restricted in, for example, the space where the coil is accommodated and the weight of the coil. Accordingly, it is difficult to increase the width of the receiving coil L2 and increase the number of Litz wires to cause adverse conditions for decreasing the value of the receiving coil series resistor r2 of the receiving coil L2. As a result, it is difficult to increase the quality factor ω0*L2/r2 of the receiving coil L2.

In contrast, the feeding coil L1 has relatively reduced conditions for, for example, the space in which the coil is accommodated and the weight of the coil, compared with the receiving coil L2, and it is relatively easy to increase the quality factor ω0*L1/r1 of the feeding coil L1. Accordingly, the quality factor ω0*L1/r1 of the feeding coil L1 is supposed to be higher than or equal to the quality factor ω0*L2/r2 of the receiving coil L2 in the wireless power transmission system.

A hatched portion in FIG. 6 indicates an area in which ω0*L2/RL is not lower than two and is not higher than 12, in which both the power transmission efficiency of 20% or higher with the coupling coefficient k being set to 0.05 and the power transmission efficiency of 80% or higher with the coupling coefficient k being set to 0.5 are satisfied, and in which the condition that the quality factor ω0*L1/r1 of the feeding coil L1 is higher than or equal to the quality factor ω0*L2/r2 of the receiving coil L2 is satisfied, in a graph indicating the relationship between the quality factor ω0*L1/r1 of the feeding coil L1 and the quality factor ω0*L2/r2 of the receiving coil L2.

The resonant angular frequency ω0 is equal to 628318.5 rad/sec when the resonant frequency f0 is set to 100 kHz, and setting the inductance value of the receiving coil L2 to 100 μH and the value of the load RL to 31.4Ω makes ω0*L2/RL equal to two.

When the inductance value of the feeding coil L1 is set to 100 μH, the capacitance value of the receiving capacitor C2 is equal to 0.0253 μF from the inductance value of the receiving coil L2 and the resonant frequency f0.

When ω0*L2/RL is not lower than two and is not higher than 12, in order to satisfy both the power transmission efficiency of 20% or higher with the coupling coefficient k being set to 0.05 and the power transmission efficiency of 80% or higher with the coupling coefficient k being set to 0.5 and to satisfy the condition that the quality factor ω0*L1/r1 of the feeding coil L1 is higher than or equal to the quality factor ω0*L2/r2 of the receiving coil L2, the quality factor ω0*L1/r1 of the feeding coil L1 has a value of 55 or higher when the quality factor ω0*L2/r2 of the receiving coil L2 has a value that is 50 or higher and lower than 55 and the quality factor ω0*L1/r1 of the feeding coil L1 is higher than or equal to the quality factor ω0*L2/r2 of the receiving coil L2 when the quality factor ω0*L2/r2 of the receiving coil L2 has a value of 55 or higher.

As described above, when ω0*L2/RL is not lower than two and is not higher than 12 and when the quality factor ω0*L2/r2 of the receiving coil L2 has a value of 50 or higher and lower than 55, making the value of the quality factor ω0*L1/r1 of the feeding coil L1 55 or higher, or when ω0*L2/RL is not lower than two and is not higher than 12 and when the quality factor ω0*L2/r2 of the receiving coil L2 has a value of 55 or higher, making the value of the quality factor ω0*L1/r1 of the feeding coil L1 higher than or equal to that of the quality factor ω0*L2/r2 of the receiving coil L2 allow both the power transmission efficiency of 20% or higher with the coupling coefficient k being set to 0.05 and the power transmission efficiency of 80% or higher with the coupling coefficient k being set to 0.5, which are practically required for the wireless power transmission, to be satisfied.

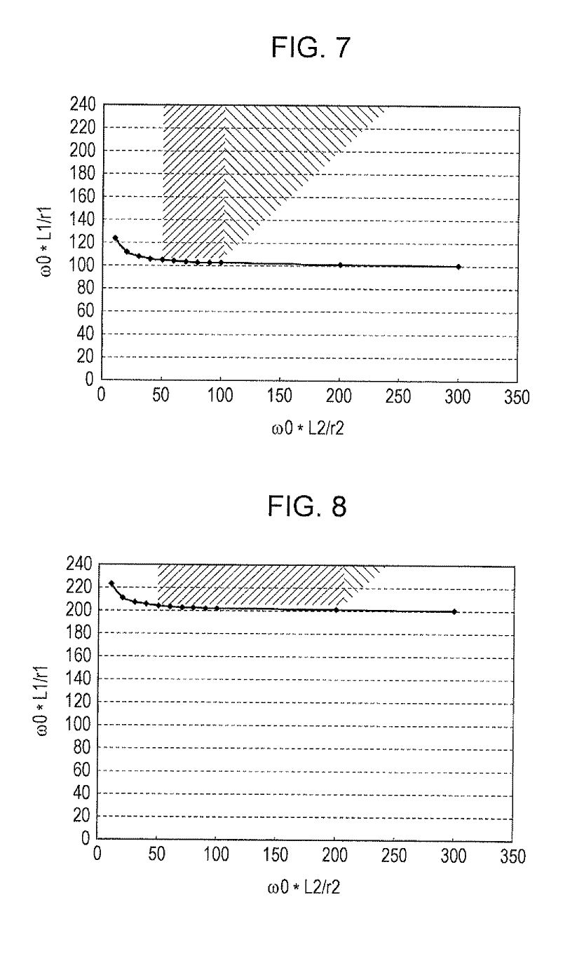

A hatched portion in FIG. 7 indicates an area in which ω0*L2/RL is not lower than one and is lower than two, in which both the power transmission efficiency of 20% or higher with the coupling coefficient k being set to 0.05 and the power transmission efficiency of 80% or higher with the coupling coefficient k being set to 0.5 are satisfied, and in which the condition that the quality factor ω0*L1/r1 of the feeding coil L1 is higher than or equal to the quality factor ω0*L2/r2 of the receiving coil L2 is satisfied, in a graph indicating the relationship between the quality factor ω0*L1/r1 of the feeding coil L1 and the quality factor ω0*L2/r2 of the receiving coil L2.

The resonant angular frequency ω0 is equal to 628318.5 rad/sec when the resonant frequency f0 is set to 100 kHz, and setting the inductance value of the receiving coil L2 to 100 μH and the value of the load RL to 62.8Ω makes ω0*L2/RL equal to one.

When the inductance value of the feeding coil L1 is set to 100 μH, the capacitance value of the receiving capacitor C2 is equal to 0.0253 μF from the inductance value of the receiving coil L2 and the resonant frequency f0.

When ω0*L2/RL is not lower than one and is lower than two, in order to satisfy both the power transmission efficiency of 20% or higher with the coupling coefficient k being set to 0.05 and the power transmission efficiency of 80% or higher with the coupling coefficient k being set to 0.5 and to satisfy the condition that the quality factor ω0*L1/r1 of the feeding coil L1 is higher than or equal to the quality factor ω0*L2/r2 of the receiving coil L2, the quality factor ω0*L1/r1 of the feeding coil L1 has a value of 105 or higher when the quality factor ω0*L2/r2 of the receiving coil L2 has a value that is 50 or higher and lower than 105 and the quality factor ω0*L1/r1 of the feeding coil L1 is higher than or equal to the quality factor ω0*L2/r2 of the receiving coil L2 when the quality factor ω0*L2/r2 of the receiving coil L2 has a value of 105 or higher.

As described above, when ω0*L2/RL is not lower than one and is lower than two and when the quality factor w0*L2/r2 of the receiving coil L2 has a value of 50 or higher and lower than 105, making the value of the quality factor w0*L1/r1 of the feeding coil L1 105 or higher, or when w0*L2/RL is not lower than one and is lower than two and when the quality factor w0*L2/r2 of the receiving coil L2 has a value of 105 or higher, making the value of the quality factor w0*L1/r1 of the feeding coil L1 higher than or equal to that of the quality factor w0*L2/r2 of the receiving coil L2 allow both the power transmission efficiency of 20% or higher with the coupling coefficient k being set to 0.05 and the power transmission efficiency of 80% or higher with the coupling coefficient k being set to 0.5, which are practically required for the wireless power transmission, to be satisfied.

A hatched portion in FIG. 8 indicates an area in which ω0*L2/RL is not lower than 0.5 and is lower than one, in which both the power transmission efficiency of 20% or higher with the coupling coefficient k being set to 0.05 and the power transmission efficiency of 80% or higher with the coupling coefficient k being set to 0.5 are satisfied, and in which the condition that the quality factor ω0*L1/r1 of the feeding coil L1 is higher than or equal to the quality factor ω0*L2/r2 of the receiving coil L2 is satisfied, in a graph indicating the relationship between the quality factor ω0*L1/r1 of the feeding coil L1 and the quality factor ω0*L2/r2 of the receiving coil L2.

The resonant angular frequency ω0 is equal to 628318.5 rad/sec when the resonant frequency f0 is set to 100 kHz, and setting the inductance value of the receiving coil L2 to 100 μH and the value of the load RL to 125.6Ω makes ω0*L2/RL equal to 0.5.

When the inductance value of the feeding coil L1 is set to 100 μH, the capacitance value of the receiving capacitor C2 is equal to 0.0253 μF from the inductance value of the receiving coil L2 and the resonant frequency f0.

When ω0*L2/RL is not lower than 0.5 and is lower than one, in order to satisfy both the power transmission efficiency of 20% or higher with the coupling coefficient k being set to 0.05 and the power transmission efficiency of 80% or higher with the coupling coefficient k being set to 0.5 and to satisfy the condition that the quality factor ω0*L1/r1 of the feeding coil L1 is higher than or equal to the quality factor ω0*L2/r2 of the receiving coil L2, the quality factor ω0*L1/r1 of the feeding coil L1 has a value of 205 or higher when the quality factor ω0*L2/r2 of the receiving coil L2 has a value that is 50 or higher and lower than 205 and the quality factor ω0*L1/r1 of the feeding coil L1 is higher than or equal to the quality factor ω0*L2/r2 of the receiving coil L2 when the quality factor ω0*L2/r2 of the receiving coil L2 has a value of 205 or higher.

As described above, when ω0*L2/RL is not lower than 0.5 and is lower than one and when the quality factor w0*L2/r2 of the receiving coil L2 has a value of 50 or higher and lower than 205, making the value of the quality factor w0*L1/r1 of the feeding coil L1 205 or higher, or when w0*L2/RL is not lower than 0.5 and is lower than one and when the quality factor w0*L2/r2 of the receiving coil L2 has a value of 205 or higher, making the value of the quality factor w0*L1/r1 of the feeding coil L1 higher than or equal to that of the quality factor w0*L2/r2 of the receiving coil L2 allow both the power transmission efficiency of 20% or higher with the coupling coefficient k being set to 0.05 and the power transmission efficiency of 80% or higher with the coupling coefficient k being set to 0.5, which are practically required for the wireless power transmission, to be satisfied.

Also in the second embodiment, no capacitor is provided for the feeding coil L1 in series and in parallel. In addition, the parasitic capacitance component occurring at the feeding coil L1 is much smaller than that occurring at the receiving capacitor C2. Accordingly, the power feeding unit does not form a resonance circuit using the resonant frequency f0 of the power receiving series LC resonance circuit 125 as the resonance point. Accordingly, the problem in that the variation in distance between the feeding coil L1 and the receiving coil L2 varies the frequencies having high power transmission efficiencies does not occur. Furthermore, since no capacitor is required in the power feeding unit, the number of the components is reduced to achieve advantages in size and cost.

The wireless power transmission system 100 according to the embodiments has been described above. With the wireless power transmission system 100, it is possible to realize the high power transmission efficiency even with an air gap or a positional shift between the feeding coil and the receiving coil within a certain coupling coefficient range by appropriately setting the impedance ratio between the receiving coil and the load, the quality factor of the feeding coil, and the quality factor of the receiving coil.

As described above, the wireless power transmission system according to the embodiments of the present invention is useful for non-contact power transmission to, for example, mobile phones, portable music players, game machines, delivery robots in factories, or electrical vehicles.

What is claimed is:

1. A wireless power transmission system comprising:
a wireless power feeder; and
a wireless power receiver,
wherein the wireless power feeder includes a feeding coil and a power circuit that supplies alternating current to the feeding coil at a drive frequency to cause the feeding coil to feed alternating current power to a receiving coil,
wherein the wireless power receiver includes the receiving coil, a receiving capacitor forming a series resonance circuit with the receiving coil, and a load that consumes the alternating current power received from the feeding coil by the receiving coil, and
wherein, when ω0*L2/RL resulting from division of a product of a resonant angular frequency ω0, which is a product of a resonant frequency determined by the receiving coil and the receiving capacitor and 2π, and an inductance value L2 of the receiving coil by a value RL of the load is not lower than two and is not higher than 12, a quality factor of the receiving coil is 50 or higher and a quality factor of the feeding coil is 55 or higher.

2. A wireless power transmission system comprising:
a wireless power feeder; and
a wireless power receiver,
wherein the wireless power feeder includes a feeding coil and a power circuit that supplies alternating current to the feeding coil at a drive frequency to cause the feeding coil to feed alternating current power to a receiving coil,
wherein the wireless power receiver includes the receiving coil, a receiving capacitor forming a series resonance circuit with the receiving coil, and a load that consumes the alternating current power received from the feeding coil by the receiving coil, and
wherein, when ω0*L2/RL resulting from division of a product of a resonant angular frequency ω0, which is a product of a resonant frequency determined by the receiving coil and the receiving capacitor and 2π, and an inductance value L2 of the receiving coil by a value RL of the load is not lower than one and is lower than two, a quality factor of the receiving coil is 50 or higher and a quality factor of the feeding coil is 105 or higher.

3. A wireless power transmission system comprising:
a wireless power feeder; and
a wireless power receiver,
wherein the wireless power feeder includes a feeding coil and a power circuit that supplies alternating current to the feeding coil at a drive frequency to cause the feeding coil to feed alternating current power to a receiving coil,
wherein the wireless power receiver includes the receiving coil, a receiving capacitor forming a series resonance circuit with the receiving coil, and a load that consumes the alternating current power received from the feeding coil by the receiving coil, and
wherein, when ω0*L2/RL resulting from division of a product of a resonant angular frequency ω0, which is a product of a resonant frequency determined by the receiving coil and the receiving capacitor and 2π, and an inductance value L2 of the receiving coil by a value RL of the load is not lower than 0.5 and is lower than one, a quality factor of the receiving coil is 50 or higher and a quality factor of the feeding coil is 205 or higher.

4. The wireless power transmission system according to claim 1,
wherein, when the quality factor of the receiving coil is 50 or higher and lower than 55, the quality factor of the feeding coil is 55 or higher, and when the quality factor of the receiving coil is 55 or higher, the quality factor of the feeding coil is higher than or equal to the quality factor of the receiving coil.

5. The wireless power transmission system according to claim 2,
wherein, when the quality factor of the receiving coil is 50 or higher and lower than 105, the quality factor of the feeding coil is 105 or higher, and when the quality factor of the receiving coil is 105 or higher, the quality factor of the feeding coil is higher than or equal to the quality factor of the receiving coil.

6. The wireless power transmission system according to claim 3,
wherein, when the quality factor of the receiving coil is 50 or higher and lower than 205, the quality factor of the feeding coil is 205 or higher, and when the quality factor of the receiving coil is 205 or higher, the quality factor of the feeding coil is higher than or equal to the quality factor of the receiving coil.

7. The wireless power transmission system according to claim 4,
wherein the wireless power feeder is configured so as to include no capacitor in series or in parallel for the feeding coil.

8. The wireless power transmission system according to claim 5,
wherein the wireless power feeder is configured so as to include no capacitor in series or in parallel for the feeding coil.

9. The wireless power transmission system according to claim 6,
wherein the wireless power feeder is configured so as to include no capacitor in series or in parallel for the feeding coil.
